(19) United States
(12) Patent Application Publication
(10) Pub. No.: US 2009/0290331 A1
(43) Pub. Date: Nov. 26, 2009

(54) ILLUMINATING APPARATUS

(76) Inventor: Robert J. Jacobs, Hays, KS (US)

Correspondence Address: JAY M. SCHLOFF, 6960 Orchard Lake Road, Suite 315, West Bloomfield, MI, 48322, US

(21) Appl. No.: 12/425,797

(22) Filed: Apr. 17, 2009

Related U.S. Application Data
(60) Provisional application No. 61/054,557, filed on May 20, 2008.

(51) Int. Cl. F21V 33/00

(52) U.S. Cl. 362/155

(57) ABSTRACT

An illuminating apparatus is mountable to a storage container including a lid member capable of assuming an open position and a closed position. The illuminating apparatus comprises at least one light source, a power supply source, a switching mechanism, and at least one sensing member. The at least one light source provides illumination. The power supply source supplies power to the at least one light source. The switching mechanism is configured to assume an on-position and an off-position for actuating the supply of power from the power supply source to the at least one light source. The at least one sensing member is capable of sensing the open position and the closed position of the lid member, when the switching mechanism is at the on-position and further capable of actuating the at least one light source for providing illumination on detecting the open position of the lid member.

### CROSS-REFERENCE TO RELATED APPLICATIONS

The present invention claims priority under 35 United States Code, Section 119 on the U.S. Provisional Patent Application No. 61/054,557 filed on May 20, 2008, the disclosure of which is incorporated by reference.

### FIELD OF THE INVENTION

The present invention relates, in general, to lighting equipment, and, more particularly, to an illuminating apparatus capable of being mounted to a storage container, such as a cooler, for facilitating an individual to select a desired article from within the storage container during nighttime or such dimly lit environmental conditions.

### BACKGROUND OF THE INVENTION

Storage containers are used for storing articles and are available in variety of shapes and sizes. Storage containers may also be configured to preserve a quality of article, such as a food article, stored therein. For example, some thermally insulated storage containers, commonly referred to as coolers are used to preserve a quality of articles, such as food and beverage stored therein. Typically, a cooler includes a tub, and a lid pivotally attached thereto for being movable between a closed position and an open position. The lid, at the open position, provides accessibility to an interior area of the tub for storing and evacuating the articles.

Generally, such coolers are used for outdoor activities, such as camping, boating, bonfires and the like. During daytime or such fairly lit environmental conditions, at the open position of the lid, the articles stored in the tub are clearly visible to an individual to easily select a desired article for utilization thereof. However, during nighttime or such dimly lit environmental conditions, a task of selecting the desired article from the articles stored in the tub becomes cumbersome to the individual. Generally, in such dimly lit environmental conditions, the articles stored in the tub of the cooler may not be clearly visible to the individual resulting in selection of other similarly shaped articles instead of the desired article. Repetition of such selection of other similarly shaped articles instead of the desired article may be irritating to the individual and may additionally be time-consuming. Typically, such a problem may be overcome by using a hand-held flashlight to view the articles stored in the tub of the cooler.

In dimly lit environmental conditions, the individual may search the desired article from the articles stored in the tub by gripping the hand-held flashlight in one hand thereof, and utilizing other hand to move the lid at the open position, and to accordingly manipulate the articles stored in the tub. However, gripping the hand-held flashlight in one hand thereof, and utilizing the other hand to manipulate the articles may cause difficulties in locating the desired article, as the articles stored in the tub may often be submersed in ice water, and may be slippery. Additionally, manipulating and locating the desired article may be increasingly cumbersome if the lid has to be held in the open position by the individual utilizing one hand thereof.

Accordingly, there exists a need for facilitating an individual to select a desired article from within a storage container, such as a cooler, during nighttime and/or such dimly lit environmental conditions, in a timely and convenient manner.

### SUMMARY OF THE INVENTION

In view of the foregoing disadvantages inherent in the prior-art, the general purpose of the present invention is to provide an illuminating apparatus capable of being mounted to a storage container, to include all advantages of the prior art, and to overcome the drawbacks inherent in the prior art.

An object of the present invention is to facilitate an individual to select a desired article from within a storage container, such as a cooler, during nighttime and/or such dimly lit environmental conditions, in a timely and convenient manner.

In light of the above object, in an aspect of the present invention an illuminating apparatus is provided. The illuminating apparatus is capable of being mounted to a storage container. The storage container includes a lid member capable of assuming an open position and a closed position. The illuminating apparatus includes at least one light source, a power supply source, a switching mechanism, and at least one sensing member. The at least one light source is capable of providing illumination. The power supply source is capable of supplying power to enable the at least one light source to provide illumination. Further, the switching mechanism is configured to assume an on-position and an off-position for actuating supply of power from the power supply source to the at least one light source. Furthermore, the at least one sensing member is capable of sensing the open position and the closed position of the lid member, when the switching mechanism is at the on-position and is further capable of actuating the at least one light source for providing illumination on detecting the open position of the lid member.

The illuminating apparatus, as disclosed above, is capable of being mounted to the storage container, such as a cooler, to facilitate an individual to select a desired article from within the storage container during nighttime and/or such dimly lit environmental conditions, in a timely and convenient manner. More particularly, the illuminating apparatus provides a hands-free mechanism, which may be permanently mounted to the storage container, or may be produced as a retrofit device that may be mountable to the storage container when required. Further, the at least one light source of the illuminating apparatus is automatically illuminated, when the lid of the storage container is at the open position. The illuminating apparatus provides sufficient illumination to an inside portion of the storage container to facilitate the individual to clearly view articles during nighttime and/or such dimly lit environmental conditions for easily manipulating the articles and locate the desired article from the storage container.

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of an illuminating apparatus, in accordance with an embodiment of the present invention;

FIG. 2 illustrates a side perspective view of the illuminating apparatus of FIG. 1, in accordance with an embodiment of the present invention;

FIG. 3 illustrates a schematic view of an electric circuit of an illuminating apparatus, in accordance with an exemplary embodiment of the present invention;

FIG. 4 illustrates an exemplary mounting arrangement configured on a bottom surface of the illuminating apparatus of FIG. 1 for mounting the illuminating apparatus to a storage container, in accordance with an embodiment of the present invention; and

FIG. 5 illustrates an illuminating apparatus mounted to a storage container, in accordance with an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “first,” “second,” and the like, herein do not denote any order, elevation or importance, but rather are used to distinguish placement of one element over another. Further, the terms “a” and “an” herein do not denote a limitation of quantity, but rather denote the presence of at least one of the referenced item.

The present invention provides an illuminating apparatus capable of being mounted to the storage container, such as a cooler. The illuminating apparatus facilitates an individual to select a desired article from articles stored within the storage container, during nighttime and/or such dimly lit environmental conditions, in a timely and convenient manner. The illuminating apparatus may be permanently mounted to the storage container, or may be produced as a retrofit device that may be mountable to the storage container when required.

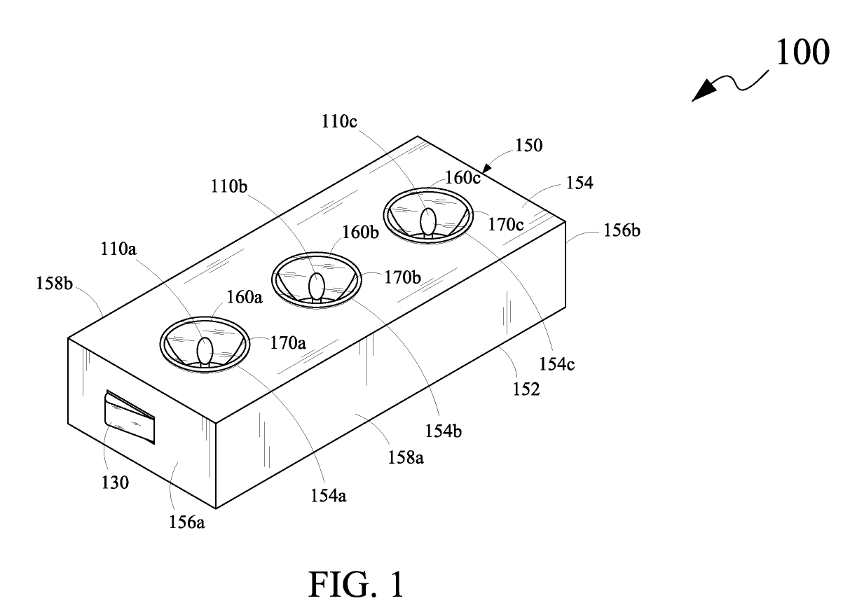

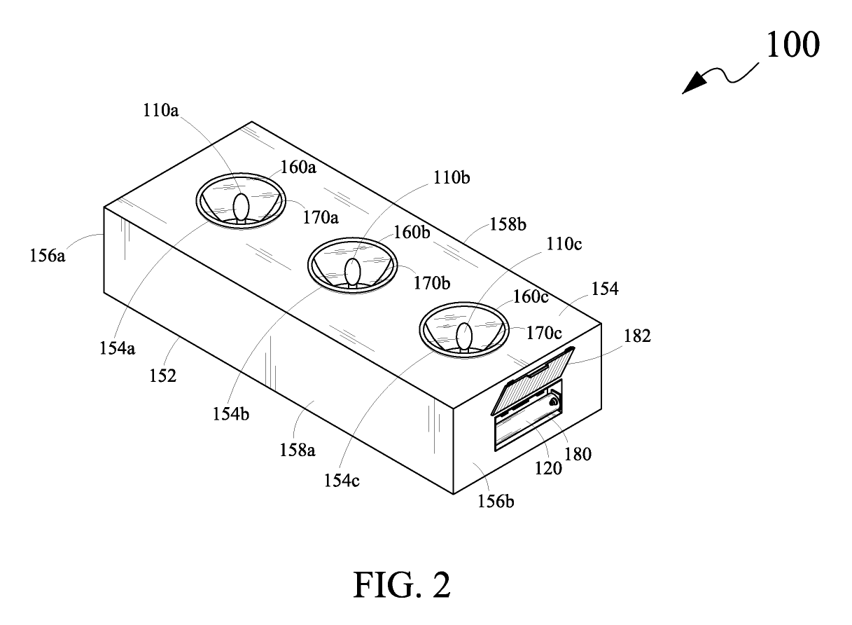

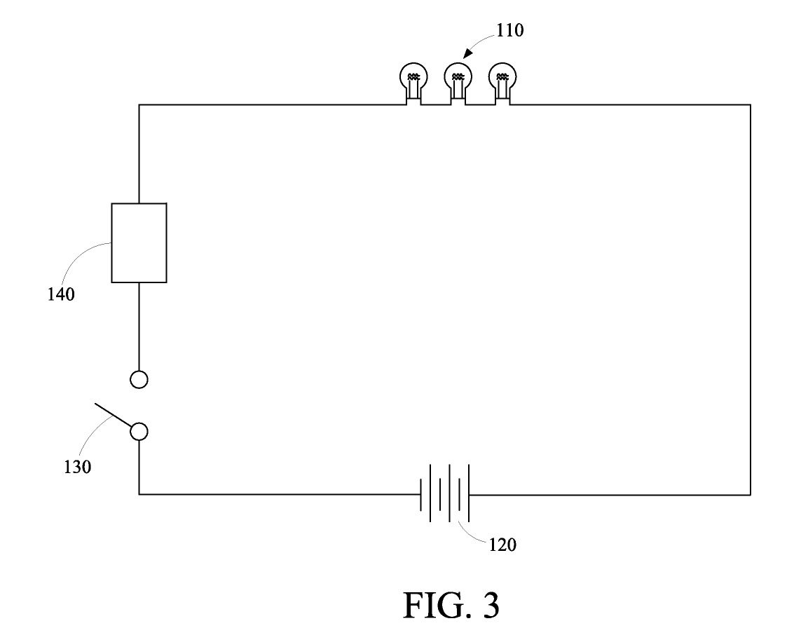

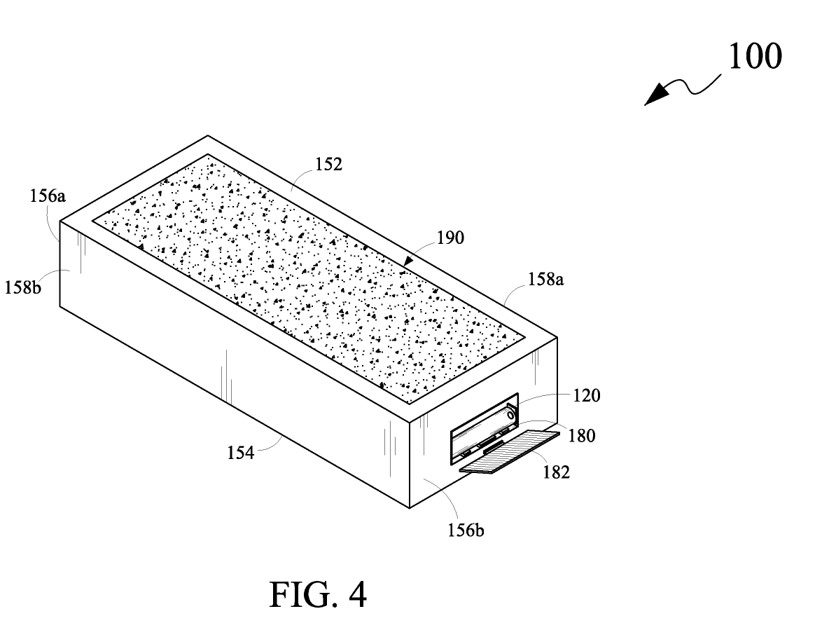

Referring now to FIGS. 1 to 4, an illuminating apparatus 100 is illustrated, in accordance with an embodiment of the present invention. More particularly, FIG. 1 illustrates a perspective view of the illuminating apparatus 100, FIG. 2 illustrates a side perspective view of the illuminating apparatus 100 of FIG. 1, FIG. 3 illustrates a schematic view of an electric circuit of the illuminating apparatus 100, and FIG. 4 illustrates an exemplary mounting arrangement configured on a bottom surface of the illuminating apparatus 100 for mounting the illuminating apparatus 100 to a storage container.

The illuminating apparatus 100 includes at least one light source, such as a first light source 110a, a second light source 110b, and a third light source 110c, a power supply source 120 (as shown in FIG. 2), a switching mechanism 130, and at least one sensing member, such as a sensing member 140 (as shown in FIG. 3). The first light source 110a, the second light source 110b and the third light source 110c are hereinafter collectively referred to as light sources 110 (not shown). The illuminating apparatus 100 further includes a housing 150 for receiving the light sources 110, the power supply source 120, the switching mechanism 130, and the sensing member 140 therein. Further, the light sources 110, the power supply source 120, the switching mechanism 130, and the sensing member 140 are electrically coupled to each other, as shown in FIG. 3. The light sources 110 are capable of providing illumination on receiving power from the power supply source 120. Furthermore, the switching mechanism 130 is configured to assume an on-position and an off-position to turn-on, and to turn-off, respectively, for actuating supply of power from the power supply source 120 to light sources 110.

The illuminating apparatus 100 is capable of being mounted to a storage container (not shown). The storage container may include a lid member (not shown) pivotally coupled thereto. The lid member may be movable between an open position and a closed position. The illuminating apparatus 100 along with the storage container will be described in detail herein with reference to FIG. 4. The illuminating apparatus 100, when mounted on the lid member, the sensing member 140 disposed within the housing 150 is capable of sensing the open position and the closed position of the lid member for enabling the power supply source 120 to supply the power to the light sources 110 to provide illumination. More particularly, the sensing member 140 is capable of actuating the light sources 110 for providing illumination on detecting the open position of the lid member. The light sources 110 provide illumination to facilitate an individual (not shown) to select a desired article from articles stored within the storage container, during nighttime or such dimly lit environmental conditions, in a timely and convenient manner.

As shown in FIGS. 1 and 2, the housing 150 includes a bottom surface 152, a top windowed surface 154, and two pairs of opposite side surfaces, such as first side surfaces 156a and 156b, and second side surfaces 158a and 158b. The first side surfaces 156a and 156b, and the second side surfaces 158a and 158b are disposed between the bottom surface 152 and the top windowed surface 154 for configuring an interior area (not shown). The top windowed surface 154 includes three windows, such as a first window 154a, a second window 154b, and a third window 154c, wherein each of the first window 154a, the second window 154b, and the third window 154c may be covered by a transparent glass. For example, the first window 154a may be covered by a first transparent glass 160a, a second window 154b may be covered by a second transparent glass 160b, and a third window 154c may be covered by a third transparent glass 160c. Further, the first light source 10a, the second light source 110b, and the third light source 110c are held within the interior area of the housing 150 such that, the first light source 110a, the second light source 110b, and the third light source 110c are exhibited from the first window 154a, the second window 154b, and the third window 154c, respectively. More particularly, the first light source 110a, the second light source 110b, and the third light source 110c are held within the housing 150 such that the first light source 110a, the second light source 110b, and the third light source 110c are capable of providing illumination through the first window 154a, the second window 154b, and the third window 154c of the top windowed surface 154, respectively.

Further, the first light source 110a, the second light source 110b, and the third light source 110c include a first refractive cone arrangement 170a, a second refractive cone arrangement 170b, and a third refractive cone arrangement 170c, respectively, configured thereto, such that the first light source 110a, the second light source 110b, and the third light source 110c provides concentrated illumination through the first window 154a, the second window 154b, and the third window 154c of the top windowed surface 154, respectively. More particularly, each of the first refractive cone arrangement 170a, the second refractive cone arrangement 170b, and the third refractive cone arrangement 170c includes a cone-shaped member with a cone-tip portion cutoff to configure an opening for receiving the first light source 110a, the second light source 110b, and the third light source 110c, respectively. Further, the cone-shaped member of each of the first refractive cone arrangement 170a, the second refractive cone arrangement 170b, and the third refractive cone arrangement 170c is disposed on an inner surface (not shown) of the first transparent glass 160a, the second transparent glass 160b and the third transparent glass 160c, respectively, such that the first light source 110a, the second light source 110b and the third light source 110c face the inner surface (not shown) of the first transparent glass 160a, the second transparent glass 160b and the third transparent glass 160c, respectively. Such arrangement of the first refractive cone arrangement 170a, the second refractive cone arrangement 170b, and the third refractive cone arrangement 170c enables the first light source 110a, the second light source 110b and the third light source 110c to provide concentrated illumination through the first window 154a, the second window 154b and the third window 154c, respectively. It will be evident to a person skilled in the art that illuminating apparatus 100 with three light sources is depicted for exemplary purposes only and that the illuminating apparatus 100 may include any such number of light sources for providing illumination thereof. Moreover, for any such number of light sources, the illuminating apparatus 100 may accordingly be configured with an equivalent number of windows, transparent glasses and refractive cone arrangements for providing concentrated illumination thereof.

The light sources 110 are electrically coupled to the power supply source 120 and the switching mechanism 130. At the on-position of the switching mechanism 130, the power supply source 120 is capable of providing the power for illuminating the light sources 110. The power supply source 120 and the switching mechanism 130 are disposed on side surfaces of the housing 150, as shown in FIGS. 1 and 2. More particularly, the switching mechanism 130 is mounted on the first side surface 156a of the housing 150 (as shown in FIG. 1). The switching mechanism 130 is configured to assume the on-position and the off-position and is capable of actuating the supply of power to the light sources 110 via the power supply source 120, upon sensing the open position of the lid member.

Further, the power supply source 120 is provided within a power supply source compartment 180 (hereinafter referred to as ‘compartment 180’) configured on a portion of the housing 150. Without departing from the scope of the present invention, the compartment 180 may be configured on the first side surface 156b (as shown in FIG. 2) of the housing 150. The compartment 180 is capable of receiving the power supply source 120 for powering the light sources 110 to provide illumination. Further, the compartment 180 may include a cover 182 for covering thereto upon insertion of the power supply source 120 within the compartment 180.

In one embodiment of the present invention, the power supply source 120 used for providing the power to the light sources 110, is a battery. In FIG. 2, one battery is shown within the compartment 180 to provide the power to the light sources 110, however, it will be evident to a person skilled in the art to include more than one battery, such as two or three batteries within a compartment, such as the compartment 180. Such a battery may be a rechargeable battery, as per preference of the individual. Further, each of the light sources 110 used in the illuminating apparatus 100 may be light emitting diode (LED). However, it will be evident to a person skilled in the art to use other light source, such as an electro-luminescence for providing illumination. The actuation of supply of power from the power supply source 120 to the light sources 110 is further explained in conjunction with FIG. 3.

FIG. 3 depicts a schematic view of the electric circuit of the illuminating apparatus 100 for illustrating an electrical coupling among the light sources 110, the power supply source 120, the switching mechanism 130, and the sensing member 140. The electric circuit is activated upon insertion of the power supply source 120 in the compartment 180 of the housing 150 (as shown in FIG. 2). Further, when the switching mechanism 130 is at the off-position, the electric circuit is opened, thereby restricting the supply of power from the power supply source 120 to the light sources 110. Further, when the switching mechanism 130 is at the on-position, the electric circuit is closed, thereby allowing the power supply from the power supply source 120 to the light sources 110. At the on-position of the switching mechanism 130, the sensing member 140 is capable of sensing the open position and the closed position of the lid member, and accordingly actuates the light sources 110. More particularly, the sensing member 140, upon sensing the open position of the lid member, actuates the light sources 110 to turn-on for providing illumination. Further, the sensing member 140 on sensing the closed position of the lid member actuates the light sources 110 to turn-off.

In one embodiment of the present invention, the sensing member 140 is an infrared sensor. However it will be evident to a person skilled in the art that the sensing member 140 may include any such sensor for sensing motion of the lid member and determining the open position and the closed position of the lid member.

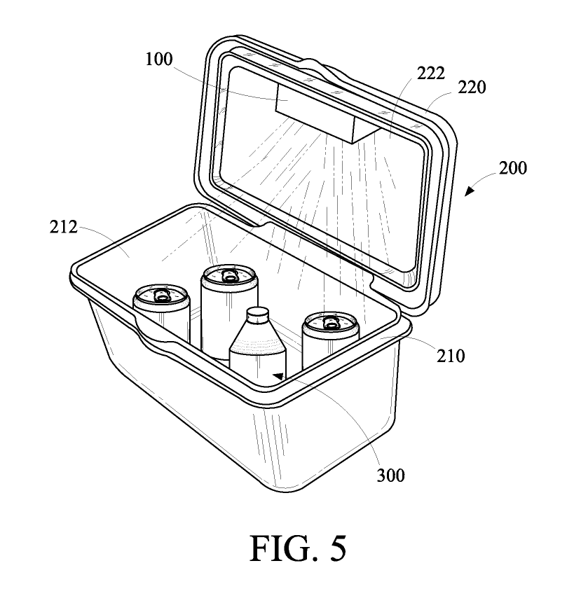

FIG. 4 illustrates an exemplary mounting arrangement 190 configured on the bottom surface 152 of the illuminating apparatus 100 for mounting the illuminating apparatus 100 to a storage container (not shown). As explained in conjunction with FIGS. 1 to 3, the illuminating apparatus 100 may be mounted onto a lid member of the storage container. In FIG. 4, the mounting arrangement 190 is depicted to be a hook and loop fastening arrangement, such as a Velcro arrangement. It will be evident to those skilled in the art that the bottom surface 152 may be configured with one of a loop fastening arrangement and a hook fastening arrangement, and, that the lid member may include a portion configured with a complimentary fastening arrangement for mounting the illuminating apparatus 100 onto the lid member. Further, it will be obvious to a person skilled in the art that mounting arrangement 190 is depicted to be a hook and loop arrangement for exemplary purposes only and that the mounting arrangement 190 may be any such arrangement, such as a screw and bolt fastener arrangement, capable of mounting the illuminating apparatus 100 onto the lid member. The illuminating apparatus 100 mounted onto the lid member of the storage container is depicted in FIG. 5.

Referring now to FIG. 5, the illuminating apparatus 100 mounted to a storage container 200 is illustrated, in accordance with an exemplary embodiment of the present invention. Herein references to FIGS. 1 to 4 will be made to describe a utility of the illuminating apparatus 100 in light of the storage container 200.

In one embodiment of the present invention, the storage container 200 may be a thermally insulated container, commonly, referred to as a cooler. However, the storage container 200 may be a tool box, fishing tackle box, and the like, and the container 200 is not limited to any particular size. The storage container 200 includes a tub member 210, and a lid member 220 pivotally coupled to the tub member 210. The lid member 220 is capable of assuming an open position and a closed position with respect to the tub member 210. The tub member 210 includes an interior area 212, in which articles 300 are stored. Without departing from the scope of the present invention the articles 300 may be at least one of a food and a beverage. At the open position of the lid member 220, the articles 300 may be stored in, or evacuated from the interior area 212 of the tub member 210.

In accordance with an embodiment of the present invention, the illuminating apparatus 100 is mounted at an inner surface 222 of the lid member 220. The illuminating apparatus 100 is mounted at the inner surface 222 of the lid member 220 in such a manner that the top windowed surface 154 faces the interior area 212 of the tub member 210. More particularly, the mounting arrangement 190 configured on the bottom surface 152 is capable of mounting the illuminating apparatus 100 to the inner surface 222 of the lid member 220 for enabling the top windowed surface 154 to face the interior area 212 of the tub member 210.

During daytime, the illuminating apparatus 100 is deactivated by keeping the switching mechanism 130 at the off-position. During nighttime or such dimly lit environmental conditions, when there is insufficient light to clearly view the articles 300 stored in the interior area 212 of the tub member 210 of the storage container 200, the illuminating apparatus 100 may be activated by keeping the switching mechanism 130 at the on-position. At the on-position of the switching mechanism 130, the sensing member 140 is capable of sensing the open position and the closed position of the lid member 220. Upon sensing the open position of the lid member 220, the sensing member 140 enables the power supply source 120 to supply power to the light sources 110 for providing illumination to the interior area 212 of the tub member 210. Upon illumination of the interior area 212 of the tub member 210, the individual may clearly view the articles 300 stored in the interior area 212 of the tub member 210. The individual may accordingly manipulate the articles 300 to select a desired article from the interior area 212 of the tub member 210.

The illuminating apparatus 100, as described herein, may be configured of suitable shape and size for being properly secured onto a lid member of a storage container. In an embodiment of the present invention, the illuminating apparatus 100 bears a rectangular shape having about 1 inch to 2 inches of width, 3 inches to 4 inches of length, and ½ inches to ¾ inches of thickness. However, it will be evident to a person skilled in the art to configure the illuminating apparatus 100 of any other shape, such as square, circular, and of any other size and/or dimensions.

The present invention provides an illuminating apparatus, such as the illuminating apparatus 100, which offers the following advantages. The illuminating apparatus is mountable to the storage container, such as a cooler, to facilitate an individual to select a desired article from within the storage container during nighttime and/or such dimly lit environmental conditions, in a timely and convenient manner. More particularly, the illuminating apparatus provides a hands free system, which may be permanently mounted to the storage container, or may be produced as a retrofit device that may be mountable to the storage device when required. Further, the illuminating apparatus includes an option of being automatically activated upon sensing an open position of the storage container. Furthermore, the illuminating apparatus provides sufficient illumination to an inside portion of the storage container, thereby facilitating the individual to clearly view articles during nighttime and/or such dimly lit environmental conditions for easily manipulating the articles to locate the desired article from the storage container. With enablement of the illuminating apparatus to the storage container, the individual, either utilizing his/her one hand, may manipulate the articles to select a desired article from the interior area of the storage container.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. An illuminating apparatus capable of being mounted to a storage container, the storage container having a lid member capable of assuming an open position and a closed position, the illuminating apparatus, comprising:
at least one light source capable of providing illumination;
a power supply source capable of supplying power to the at least one light source;
a switching mechanism capable of actuating the supply of power from the power supply source to the at least one light source, the switching mechanism configured to assume an on-position and an off-position; and
at least one sensing member for sensing the open position and the closed position of the lid member when the switching mechanism is at the on-position, wherein the at least one sensing member is capable of actuating the at least one light source for providing illumination on detecting the open position of the lid member.

2. The illuminating apparatus of claim 1, further comprising a housing for receiving the at least one light source, the power supply source, the switching mechanism, and the at least one sensing member therein, the housing comprising a bottom surface, a top windowed surface, and two pairs of opposite side surfaces disposed between the bottom surface and the top windowed surface.

3. The illuminating apparatus of claim 2, wherein the at least one light source is disposed within the housing such that the at least one light source is capable of providing illumination through the top windowed surface.

4. The illuminating apparatus of claim 2, wherein each of the at least one light source comprises a refractive cone arrangement for providing concentrated illumination through the top windowed surface.

5. The illuminating apparatus of claim 2, wherein the housing further comprises a power supply source compartment configured therein for receiving the power supply source to enable the at least one light source to provide illumination.

6. The illuminating apparatus of claim 1, wherein each of the at least one light source is a Light Emitting Diode (LED).

7. The illuminating apparatus of claim 1, wherein a sensing member of the at least one sensing member is an infrared sensor.

8. The illuminating apparatus of claim 1, wherein the power supply source is a battery.
